(19) United States
(12) Patent Application Publication
(10) Pub. No.: US 2010/0223599 A1
(43) Pub. Date: Sep. 2, 2010

(54) EFFICIENT SYMBOLIC EXECUTION OF SOFTWARE USING STATIC ANALYSIS

(75) Inventors: Indradeep Ghosh, San Jose, CA (US); Daryl R. Shannon, Houston, TX (US); Sreeranga P. Rajan, Sunnyvale, CA (US)

Correspondence Address: BAKER BOTTS L.L.P., 2001 ROSS AVENUE, SUITE 600, DALLAS, TX, 75201-2980, US

(73) Assignee: FUJITSU LIMITED, Kanagawa (JP)

(21) Appl. No.: 12/395,515

(22) Filed: Feb. 27, 2009

(51) Int. Cl. G06F 11/36

(52) U.S. Cl. 717/130

(57) ABSTRACT

In one embodiment, a method includes accessing software comprising one or more inputs, one or more variables, and one or more segments of code that when executed operate on one or more of the inputs or one or more of the variables. The method includes, for every variable, determining whether the variable is relevant or irrelevant to a set of the inputs when expressed symbolically and, if the variable is relevant, instrumenting the variable and every one of the segments of code associated with the variable. A segment of code is associated with the variable if the variable affects the segment of code when executed. The method includes symbolically executing the software with every relevant variable and its associated segments of code as instrumented to test the software.

### TECHNICAL FIELD

The present disclosure generally relates to validating or verifying software.

### BACKGROUND

Validating or verifying software is a common concern among information technology (IT) organizations. Whether the software is (as an example) a desktop application for execution at one or more client computer systems or (as another example) a web application for execution at one or more server computer systems, it is often important to carefully verify the quality of the software. While some types of errors (such as bugs) in software cause only annoyance or inconvenience to users, other types of errors have the potential to cause more serious problems, possibly even resulting in financial loss. As an example, some experts estimate that the cost of security vulnerability in web applications is currently approximately $180 billion a year. As another example, some experts estimate that losses to retailers that rely on the Internet as the primary medium for customers to shop for their goods or services is currently approximately $22 billion a year in the United States, mostly as a result of consumers being reluctant to conduct business online because of concerns over online security.

Software testing is a common method of verifying the quality of software. With software testing, the software (or one or more portions of software) under analysis is put through a suite of regression tests after each revision or modification and the outputs are evaluated for correctness. However, software testing often provides only limited coverage and has a tendency to miss corner-case bugs. Formal verification tends to address these problems. Formal verification mathematically proves the satisfiability of a specific requirement on software under analysis or obtains a counterexample in the form of a test case that breaks the requirement and indicates a bug. Formal verification typically uses explicit state-based model checkers as internal proof engines. Such model checkers typically use nondeterministic user inputs in the drivers that feed the software under analysis. Such model checkers are able to work out all possible paths or scenarios encoded in a driver, but cannot work out the complete input space of primitive input variables, such as integer values, string values, Boolean values, etc. Instead, they merely operate on data values specified by the drivers.

Symbolic execution is a non-explicit state model-checking technique that treats input to software as symbol variables. It creates complex equations by executing all finite paths in the software with symbolic variables and then solves the complex equations with a solver (typically known as a decision procedure) to obtain error scenarios, if any. In contrast to explicit state model checking, symbolic execution is able to work out all possible input values and all possible uses cases of all possible input values in the software under analysis. However, while symbolic execution can exhaustively validate software under analysis, symbolic execution is computationally intensive and requires a significant amount of resources, such as processor power, memory space, etc. Moreover, even with symbolic execution, some problems are not solvable.

### BRIEF DESCRIPTION OF THE DRAWINGS

FIG. 1 illustrates an example symbolic execution applied to example software.

FIG. 2 illustrates an example system for verifying software with static analysis and symbolic execution.

FIG. 3 illustrates an example method for verifying software with static analysis and symbolic execution.

FIG. 4 illustrates an example model for relevancy analysis.

FIG. 5 illustrates an example method for relevancy analysis.

FIG. 6 illustrates an example computer system.

### DESCRIPTION OF EXAMPLE EMBODIMENTS

Particular embodiments perform static analysis on software (or one or more portions of software) under analysis to determine relevant variables and irrelevant variables in the software. Herein, reference to software encompasses one or more applications or other software, and vice versa, where appropriate. Moreover, reference to software encompasses one or more portions of software, and vice versa, where appropriate. A variable, x, is relevant to a set of one or more inputs to the software if one or more changes in one or more of the inputs in the set cause the value of the variable x to change. On the other hand, if one or more changes in one or more of the inputs in the set do not affect the value of the variable x then the variable x is irrelevant to the set of inputs. In particular embodiments, the type of static analysis performed on software under analysis is relevancy analysis.

Particular embodiments transform the source code of software under analysis with software instrumentation, which assigns symbols to the values of (or symbolic values to) relevant variables. Irrelevant variables take default values. Particular embodiments then perform symbolic execution on the instrumented source code of the software and analyze the results of the symbolic execution to verify the quality of the software under analysis.

In particular embodiments, to perform validation and verification on software, first a set of input variables are marked as symbolic entities in the software. Then static analysis is performed on the software under analysis to determine the relevant variables and the irrelevant variables in the software with respect to the set of input variables that has been marked as symbolic. The value of a relevant variable is affected if changes are made to the values on one or more of the variables in the above set of symbolic variables. The value of an irrelevant variable is not affected by such changes. The source code of the software under analysis is transformed using software instrumentation, such that the relevant variables are assigned symbols as their values. Symbolic execution is then performed on the instrumented source code of the software, and the results of the symbolic execution are analyzed to verify the quality of the software under analysis.

Symbolic execution is a formal software verification technique that is derived from symbolic computation, which uses machines, such as computers, to manipulate mathematical equations and expressions in symbolic form. As applied to software testing, symbolic execution may be used to analyze if and when errors in the source code of the software may occur, predict what code statements do to specified inputs and outputs, and consider path traversal within the software.

To test software, symbols representing arbitrary values replace normal input values, such as numbers, strings, true/false, etc., to the software. The operations used to manipulate such variables are replaced with symbolic versions of the operations so that they can manipulate symbolic formulas instead of concrete values. The software is then executed as in a normal execution. The variables usually take symbolic formulas instead of actual values. Systematic analysis is then performed on the symbolic formulas to validate and verify the software.

To further explain symbolic execution, consider the following segment of code illustrated in TABLE 1:

TABLE 1
Function “foo_1”

| | |
|---|---|
| 1 | int foo_1 (int a, int b) { |
| 2 | int c; |
| 3 | c = a + b; |
| 4 | if (c > 0) { |
| 5 | c = c + 1; |
| 6 | } |
| 7 | return c; |
| 8 | } |

The function “foo_{—}1” has two input variables, “a” and “b,” and one output variable, “c.” With normal execution of the function “foo_{—}1,” the variables “a,” “b,” and “c” may each have any integer value, such as . . . −2, −1, 0, 1, 2, . . . . With symbolic execution, the variables “a,” “b,” and “c” is each assigned a symbolic value that may represent any arbitrary integer value.

Suppose variable “a” is assigned symbolic value “x,” variable “b” is assigned symbolic value “y,” and variable value “c” is assigned symbolic “z,” where the symbolic values “x, y,” and “z” each represents an arbitrary integer value. The code statement “c=a+b” at line 3 becomes “z=x+y.” The code statement “c>0” at line 4 becomes “z>0.” The code statement “c=c+1” at line 5 becomes “z=z+1” or “z=x+y+1.”

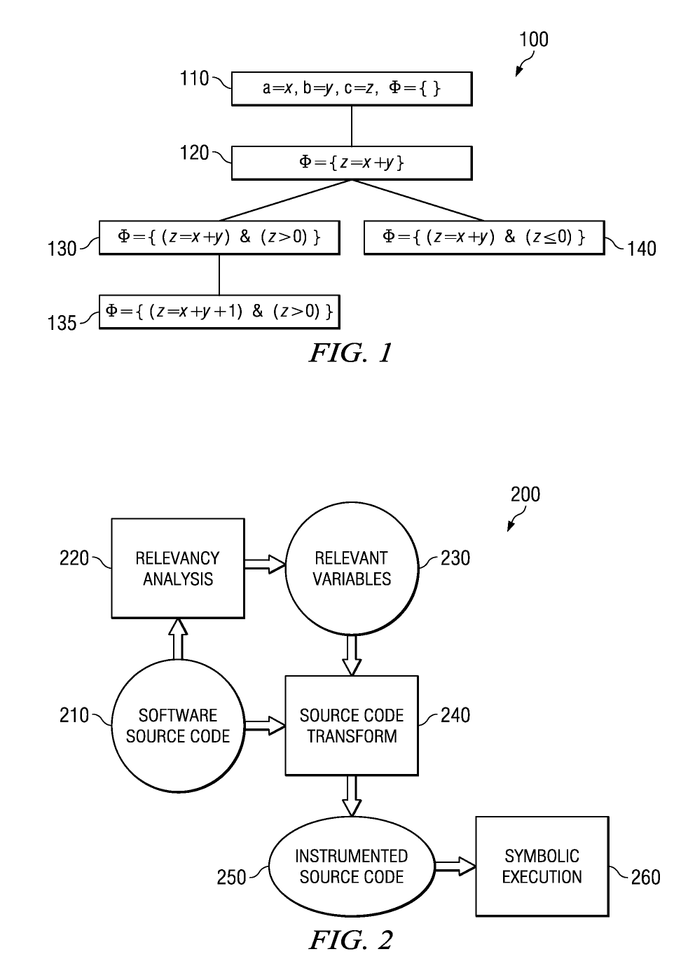

FIG. 1 illustrates the path traversal 100 of function “foo_{—}1.” The symbol “Φ” denotes the symbolic formulas to be analyzed at each step. In box 110, the three variables of function “foo_{—}1,” “a,” “b,” and “c,” are assigned symbolic values, “x, y,” and “z,” respectively. There is no symbolic formula to analyze at this point, and thus the symbol “Φ” is empty.

Box 120 corresponds to line 3 of function “foo_{—}1.” The symbolic formula to be analyzed is “z=x+y” and is represented by the symbol “Φ” The next line, line 4, of function “foo_{—}1” is a conditional “if” statement. Depending on whether the condition, e.g., “c>0” or, in symbolic form, “z>0,” is met, the code may traverse down one of the two possible paths, e.g., “z>0” or “z≦0.” Box 130 corresponds to the first path, “z>0,” and box 140 corresponds to the second path, “z≦0.”

If the code traverses down the first path, then “z” is greater than 0. In this case, the symbolic formulas to be analyzed are “z=x+y” and “z>0” (box 130), as both formulas must be satisfied. Furthermore, if the code traverses down the first path, “z>0,” then the value of “c” is incremented by 1 (line 5 of function “foo_{—}1”). In symbolic form, the code becomes “z=x+y+1.” Consequently, the symbolic formulas to be analyzed are “z=x+y+1” and “z>0” (box 135).

On the other hand, if the code traverses down the second path, then “z” is less than or equal to 0. In this case, the symbolic formulas to be analyzed are “z=x+y” and “z≦0” (box 140), again, as both formulas must be satisfied.

One way to validate function “foo_{—}1” is to negate some property or relationship on the symbolic variables and then test whether the conditions of the symbolic formulas still hold along with the negation of that property. If the conditions represented by the set of symbolic formulas do not hold, then the negation of the property is not satisfied and the property holds. Otherwise, there is a problem with the function. In other words, the validation process attempts to find a counter-example that violates some property of the symbolic variables in the function foo_{—}1. If no such counter-example can be found for many different properties, then the function is validated.

In practices, the mathematical analysis may be performed using various techniques. For example, linear programming (LP) is one technique for optimization of a linear objective function, subject to linear equality and linear inequality constraints, which may be used for validating the symbolic formulas, denoted by “Φ” In the case of function “foo_{—}1,” since all the variables are integers, integer linear programming (ILP) may be used to validate “Φ”

In box 110 of FIG. 1, the three variables of function “foo_{—}1,” “a,” “b,” and “c,” are assigned three symbolic values, “x,” “y,” and “z,” respectively, each representing an arbitrary integer value. Modifying the software program such that symbolic values can be assigned to variables and then those symbolic values manipulated is referred to as “instrumentation.” The instrumented version of function “foo_l” is shown in TABLE 2. All the extra functions required to create and manipulate symbolic variables are implemented and stored in a symbolic library. With traditional symbolic execution, the instrumentation is generally blind, such that every variable in software under analysis is transformed into symbolic form, regardless of whether the variable actually affects the final analysis and verification of the software.

TABLE 2
Instrumented version of function “foo_1”

| | |
|---|---|
| 1 | Symbolic.int foo_1 (Symbolic.int a, Symbolic.int b) { |
| 2 | Symbolic.int c; |
| 3 | c = a.plus(b); |
| 4 | if (c.greater(0)) { |
| 5 | c = c.plus(1); |
| 6 | } |
| 7 | return c; |
| 8 | } |

The function “foo_{—}1” has only a few lines of code, mainly for illustrative purposes. However, in realistic situations, the software under analysis may have many variables and many lines of code. One skilled in the art will appreciate that with blind instrumentation, the complexity of the analysis increases rapidly as the number of variables increases. Typical primitive types of variables include Boolean, Integer, Float, Character, etc. Past experiences have shown that the complexity of the symbolic execution analysis is often on the level of NP-hard (nondeterministic polynomial-time hard), such as those involving Boolean variables with Boolean equation type or Integer variables with linear equation type. Worse, some problems are not solvable, such as certain types of analysis involving Integer variables with non-linear equation type. Furthermore, the demand on resources in terms of processing power, memory, time, etc. is great for symbolic execution with blind instrumentation, even for solvable problems.

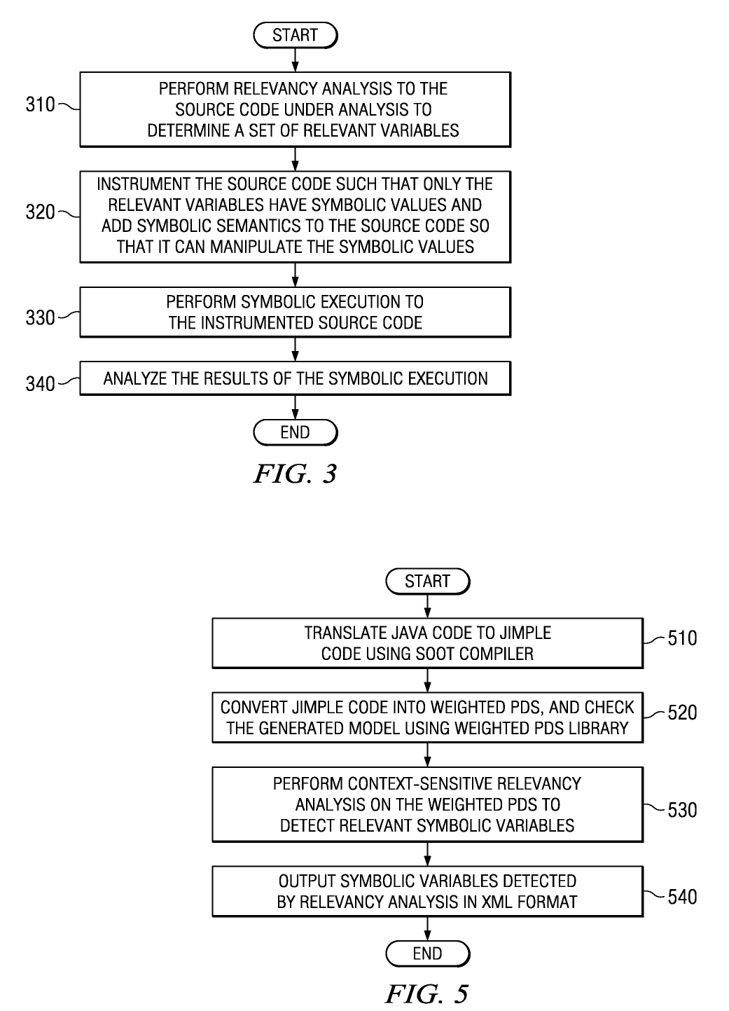

In particular embodiments, to improve the efficiency of symbolic execution, static analysis is performed on software under analysis to determine whether a variable in the software is relevant or irrelevant. Only the relevant variables are instrumented with symbolic values for symbolic execution. FIG. 2 illustrates a system 200 and FIG. 3 illustrates an example method for verifying computer software that utilizes static analysis and symbolic execution. These two figures are discussed together.

In addition, TABLE 3 illustrates another segment of code, which is used as an example for the software code under analysis. The function “foo_{—}2” again has two input variables, “a” and “b,” and one output variable, “c.” All three variables are integers, and may each have any integer value, such as . . . −2, −1, 0, 1, 2, . . . .

TABLE 3
Function “foo_2”

| | |
|---|---|
| 1 | int foo_2 (int a, int b) { |
| 2 | int c; |
| 3 | int d; |
| 4 | d = 10 * b; |
| 5 | c = a + d; |
| 6 | if (c > 0) { |
| 7 | c = c + 1; |
| 8 | } |
| 9 | return c; |
| | } |

First, static analysis is performed on the software code under analysis 210 to determine which variables in the code are relevant and which variables are irrelevant (step 310). In particular embodiments, the specific type of static analysis performed is relevancy analysis 220. More specifically, the relevancy analysis 220 is context-sensitive, field-sensitive, and flow-insensitive.

A variable may be any term in the source code 210, such as a primitive variable, a function, an argument, etc. A variable is relevant with respect to an input symbolic variable if the value of that variable is affected by changes in the value of the input variable. Otherwise the variable is irrelevant with respect to the symbolic variable.

Referring to function “foo_{—}2” illustrated in TABLE 2, suppose we specify the input “a” as symbolic, then only variable “c” in the function is relevant to “a.” Variables “b” and “d” are irrelevant with respect to input “a” as their values are unaffected by changes in the value of “a.” Thus during instrumentation of function “foo_{—}2” with only variable “a” as symbolic input, it is not necessary to instrument lines 3 and 4. However, blind instrumentation is oblivious of the above relationships and instruments those two lines as well. The static relevancy analysis step is used to mitigate the above problem.

Once the relevant and irrelevant variables 230 of the source code 210 have been determined, the source code 210 is instrumented 240 such that only the relevant variables are assigned symbolic values (step 320). The irrelevant variables may take default values, which may be pre-defined. This instrumentation process may be referred to as intelligent instrumentation, because only selected variables instead of all the variables in the source code 210 are transformed.

Symbolic execution 260 is then performed on the instrumented source code 250 (step 330), and the results of the symbolic execution are analyzed to validate and verify the source code (step 340). The analysis of the result of the symbolic execution may be performed by the same component that performs the symbolic execution on the instrumented source code, e.g., component 260, or by another separate component, e.g., a symbolic analyzer.

One skilled in the art will appreciate that the system 200 may be implemented in a variety of ways. For example, components 220, 240, and 260 may be implemented as computer software programs to perform the appropriate procedures automatically. Component 220 may be referred to as an Analyzer, component 240 may be referred to as an Instrumenter, and component 260 may be referred to as an Executor.

Component 220, the Analyzer, takes the source code under analysis 210 as input and outputs the relevant and irrelevant variables 230. In particular embodiments, the variables may be represented in XML (Extensible Markup Language) format. Component 240, the Instrumenter, takes the source code under analysis 210 and the relevant and irrelevant variables 230 as input and outputs the transformed source code 250. Component 260, the Executor, takes the instrumented source code 250 as input for validation and verification.

In particular embodiments, static analysis performed on the software under analysis 210 is a context-sensitive, field-sensitive, and flow-insensitive relevancy analysis that is based on weighted pushdown model checking techniques. As explained above, the target of the relevancy analysis is to compute the set of program variables of concerned type that are relevant to the set of designated symbolic variables. A variable is considered relevant if it may store a symbolic value given a set of symbolic inputs, which is based on the insight that program analysis may be regarded as model checking of abstract interpretation. As a result, software analysis enjoys the soundness guarantee from abstract interpretation and the automation advantages from model checking.

A push-down system (PDS) is a finite transition system that carries an unbounded stack, a finite set of control locations, finite stack alphabet, and transitions. A pushdown system is regarded as an infinite state transition system on the set of pushdown configurations, <l, c>, which is a snapshot of pushdown automata that consists of the present control location, l, and stack content, c.

A weighted pushdown system extends (WPDS) a pushdown system by associating a weight with each pushdown transition from a bounded idempotent semiring, S=(D, ⊕, [symbol] , 0, 1), where S satisfies that ⊕ is idempotent, e.g., a ⊕a=a for aεD. It also assumes that there are no infinite descending chains on D, where a ⊕ b if an only if a⊕b=a for a,bεD.

A typical encoding of a software program into a pushdown system in a flow-sensitive program analysis model considers: (1) program variables as control locations, and (2) program execution pointers as stack alphabet. To encode program data with the weighted domain where a weigh represents transfer function on the dataflow for each program execution step: f⊕g represents the merger of dataflow at the confluence of two control flows; f [symbol] g represents the composition of two sequential control flows; 1 represents that an execution step does not change each datum; and 0 represents that the program execution is interrupted by an error.

Weighted pushdown model checking answers the “meet-over-all-valid-paths” problem, denoted by MOVP (EntryPoints, TargetPoints), where EntryPoints represents a program's entry points, and TargetPoints represents the program's given execution points. It gives a summary of dataflow at the program's given execution points, e.g., TargetPoints, induced by all possible valid execution paths leading from the program's entry points, e.g., TargetPoints. A valid execution path respects that a procedure always returns to the most recent call site. This is an instance of the abstract grammar problem, and the descending chain condition of a bounded idempotent semiring provides the termination.

In particular embodiments, the analysis may be performed using various existing software products, such as Weighted PDS Library developed by Software Reliability and Security Group from University of Stuttgart and WPDS+ developed by the Computer Sciences Department from the University of Wisconsin-Madison.

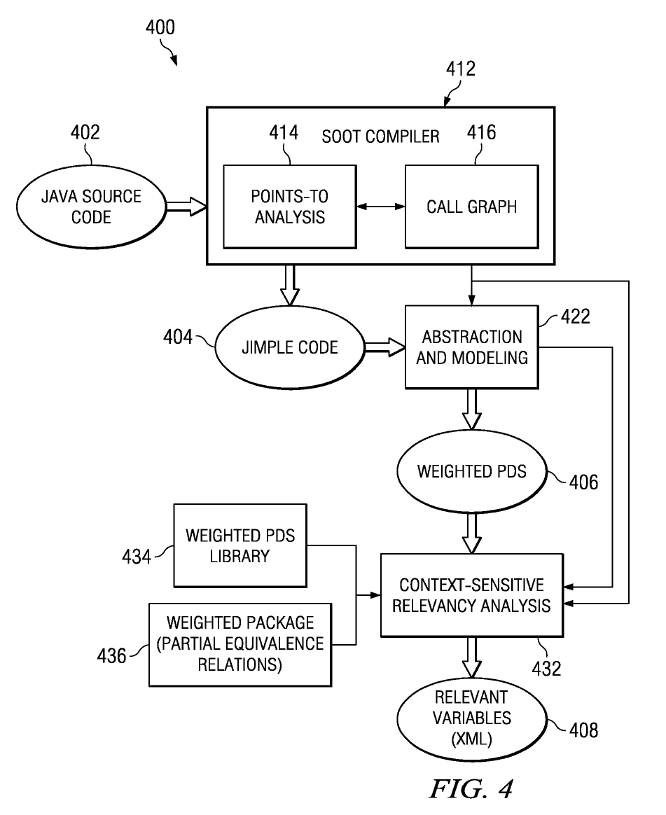

One skilled in the art will appreciate that, in practice, there may be a variety of different implementations of the relevancy analysis. FIG. 4 illustrates an example model of relevancy analysis 400 based on weighted pushdown model checking. FIG. 5 illustrates the steps of the relevancy analysis corresponding to the model illustrated in FIG. 4. FIGS. 4 and 5 are discussed together. The sample implementation illustrated in FIGS. 4 and 5 is based on the JAVA programming language, which incorporates various existing JAVA programming libraries. However, the relevancy analysis is not limited to any particular computer software programming languages.

The sample implementation of relevancy analysis, as illustrated in FIGS. 4 and 5, uses the Soot compiler 412 as the front-end and the Weighted PDS Library 434 as the back-end. Soot is a JAVA optimization framework developed by the Sable research group at McGill University. Soot provides four intermediate representations for analyzing and transforming JAVA byte-code: (1) Baf: a streamlined representation of byte-code that is simple to manipulate; (2) Jimple: a typed three-address intermediate representation suitable for optimization; (3) Shimple: an SSA (Static Single Assignment) variation of Jimple; and (4) Grimp: an aggregated version of Jimple suitable for de-compilation and code inspection.

The relevancy analysis starts with preprocessing of the JAVA code 402 under analysis from JAVA code to Jimple code 404 by Soot 412 (step 510). Jimple is a typed three-address intermediate representation of JAVA over which Points-to Analysis (PTA) 414 is performed to construct an inter-procedural call graph 416. Jimple's language construct is simpler than that of both JAVA source code and JAVA byte-code. More specifically, Soot compiler 412 provides a Static Single Assignment form in Jimple. Furthermore, although the choice of Points-to Analysis 414 is independent of relevancy analysis 432, it has an effect on the precision of relevancy analysis 432 as (1) call graph 416 construction is mutually dependent to Points-to Analysis 414 on JAVA programs, and (2) a precise modeling on instance fields such as array references and containers depends on Points-to Analysis 414 to cast aliasing.

Next, the translated Jimple code 404 is converted into a weighted PDS 406 and the generated model is checked by calling the Weighted PDS Library 434 (step 520). Context-sensitive relevancy analysis 432 is performed on the weighted PDS 406 to detect relevant symbolic variables 409 (step 530).

The relevancy analysis 432 leverages from an inter-procedural irrelevant code elimination technique. Briefly, if the change of a value at a variable does not affect the value of an output, then the variable is regarded as irrelevant. Conversely, if the change of a value at a variable does affect the value of an output, then the variable is regarded as relevant. This concept may be formalized as a weighted domain D=(λx.x, λx.ANY, λx.ID, 0) with the ordering λx.ANY⊂λx.x⊂λx.ID. They are functions on a two-pint abstract domain {ANY, ID} of partial equivalence relations (PERs), where ANY is interpreted as any values, and ID is interpreted as values being fixed. Therefore, if the computed dataflow summary for a given variable over paths leading from program entry points, e.g., EntryPoints, to target program points, e.g., TargetPoints, as a “meet-over-all-valid-paths” problem is λx.ANY, then the variable is regarded as relevant. In FIG. 4, the concept is implemented using two components, the abstraction and modeling 422 and the weighted package 436 that incorporates the partial equivalence relations.

Let env be the program environment for allocating new memories. In the analysis for symbolic execution, λx.ANY models that env assigns symbolic values to see variables; λx.ID models that env assigns program constants to variables; and λx.x models dataflow that remains unchanged along the program execution step as well as variable initialization. Since λx.ANY is the least element in the weighted domain, relevancy analysis produces a safe result for code instrumentation. It may conclude that some variable is relevant even if it is not, but not otherwise. Note that perfect safeness is difficult to achieve in practice, since it is intractable to thoroughly explore the large JAVA libraries referred to by the JAVA application under analysis. In this regard, if a variable is detected as unreachable from the entry point, then the variable is marked as relevant to avoid the possibility of overlook.

To reduce the size of the underlying model for analysis, the relevancy analysis 432 is flow insensitive, e.g., each JAVA method is regarded as a set of instructions by ignoring their execution order. Thus, a control flow graph is reduced to a call graph 416 of which each node is a set of program statements from one JAVA method.

A flow-insensitive analysis on code in Static Single Assignment form is expected to be almost as precise as flow-sensitive analysis. By encoding a call graph 416 into a pushdown system such that each JAVA method returns directly to the calling JAVA method as the return point, invocations to the same JAVA method may be distinguished from different calling JAVA methods. However, invocations are indistinguishable when the same JAVA method is multiply invoked from a JAVA method.

To remedy precision, return points are introduced in addition to JAVA method identifiers, which is a pair of class names and method signatures. Each return point is uniquely designated to a JAVA method invocation. Let Pr oS denotes method identifiers, Var denotes the set of variables, including method locals and fields, and assume a program starts with the entry point epεPr oS, then a context-sensitive relevancy analysis on a variable vεVar that resides in the method scope sεPr oS is defined as

ra(v,s)=MOVP(S,T)

where S= [symbol] env, ep [symbol] and T= [symbol] v, s.(RetP)* [symbol] . Variable v is marked as relevant if and only if ra(v, s) returns λx.ANY.

Note that regular pushdown configurations are known to be closed under forward and backward reachability, and an algorithm to compute forward reachability, e.g., successors, of regular pushdown configurations is provided in Weighted PDS Library 434. To compute MOVP(S, T), the relevancy analysis 432 (1) first constructs the weighted automation that recognizes all successors of S ; and (2) then reads out the weights by combining all pushdown configurations from T for variables of interest. Finally, the set of symbolic variables 408 detected during relevancy analysis 432 is outputted in XML format (step 540).

In particular embodiments, only variables of primitive types matter to the analysis if the complete JAVA libraries are explored in the analysis. However, it is inefficient and unnecessary to naively explore the entire set of JAVA libraries. Often, when the JAVA code under analysis is a JAVA web application, then an application-oriented explicit modeling on certain selected JAVA libraries, such as containers, strings, etc., may be provided to improve trade off on efficiency and precision. Since containers and strings are very popular devices in most actual JAVA applications, the modeling techniques provided for JAVA web applications are applicable and useful to other application scenarios as well. In particular embodiments, variables of primitive types and strings and the classes are explicitly modeled.

Strings are heavily used in JAVA programs and very important as a primitive type, especially in e-commerce applications. The space of string values is theoretically infinite. Consequently, to conduct a precise string analysis often puts too much overhead on the static analysis phase. However, because in particular embodiments a focus of static analysis as applied to strings is the relevancy relationship among the string variables, a lightweight treatment on strings generally suits the purpose.

In most JAVA programs the keys and values of containers are usually of type strings. In particular embodiments of the relevancy analysis, string constants that syntactically appear in the program, and are thus essentially bounded, are considered as distinguished string instances. The relevancy relation between strings and variables or primitive types is derived by explicitly modeling containers and some JAVA library methods.

Containers, such as vectors, tress, etc., are popular devices in JAVA applications. The particular java.util.Map interface is used extensively, e.g., to store and fetch event attributes. A precise analysis on containers is nontrivial, since the capacity or the index space of containers can be unbounded. In particular embodiments, the keys and values of java.util.Map containers that syntactically appear in the JAVA program are modeled. The treatment on containers may be similar to the treatment on instance fields; that is, based on the insight that keys of containers may be regarded as fields of JAVA class instances. Compared with modeling on instance fields, the modeling on containers differs in that keys of containers can be either string constants or more often reference variables. Therefore, both containers and keys need to be cast back to heap objects by calling Points-to Analysis. Generally speaking, the key of java.util.Map is dependent on, e.g., bounded with, the value for the put method, and vice-versa for the get method. The analysis does not need to explore container library methods provided with these explicit modeling. The pairs of containers and keys are treated as variables from a set of instance fields and array references, denoted by GlobVar.

Furthermore, JAVA library methods related to strings, e.g., java.lang.String, java.lang.StringBuffer, and implementing classes of the java.util.Map interface, are explicitly modeled. In particular, a Map container is marked as symbolic if there is any symbolic value put into it or any symbolic key obtained from it. In addition, the receiver object is relevant to all arguments for a constructor, and the return value, if any, is relevant to all method arguments as well as receiver object, if any.

Although the present disclosure describes and illustrates particular steps of the methods of FIGS. 3 and 5 occurring in a particular order, the present disclosure contemplates any suitable steps of the methods of FIGS. 3 and 5 occurring in any particular order. Moreover, although the present disclosure describes and illustrates particular components carrying out particular steps of the methods of FIGS. 3 and 5, the present disclosure contemplates any suitable components carrying out any suitable steps of the methods of FIGS. 3 and 5.

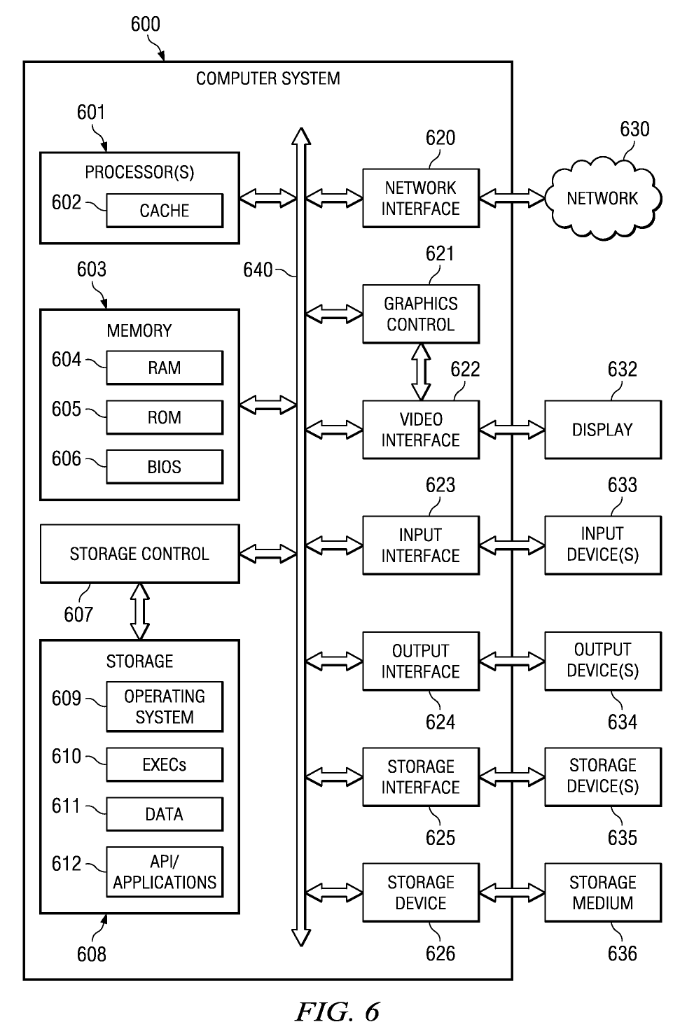

Particular embodiments may implement the methods illustrated in FIGS. 3 and 5 as computer software, which various types of computer systems may execute. As an example and not by way of limitation, FIG. 6 illustrates a computer system 600 suitable for implementing particular embodiments of the present disclosure. The components shown in FIG. 6 for computer system 600 are examples and do not limit the scope of use or functionality of any particular application programming interface (API). Neither should the configuration of components be interpreted as having any dependency or requirement relating to any one or combination of components described or illustrated with respect to computer system 600. The computer system 600 may have many physical forms including an integrated circuit, a printed circuit board, a small handheld device (such as a mobile telephone or PDA), a personal computer or a super computer. Although the present disclosure describes and illustrates a particular computer system 600 with particular components having a particular arrangement with respect to each other and other components, the present disclosure contemplates any suitable computer system with any suitable components having any suitable arrangement with respect to each other and any other suitable components.

Computer system 600 includes a display 632, one or more input devices 633 (e.g., keypad, keyboard, mouse, stylus, etc.), one or more output devices 634 (e.g., speaker), one or more storage devices 635, various types of storage medium 636.

The system bus 640 link a wide variety of subsystems. As understood by those skilled in the art, a “bus” refers to a plurality of digital signal lines serving a common function. The system bus 640 may be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 601 (also referred to as central processing units, or CPUs) optionally contain a cache memory unit 602 for temporary local storage of instructions, data, or computer addresses. Processor(s) 601 are coupled to storage devices including memory 603. Memory 603 includes random access memory (RAM) 604 and read-only memory (ROM) 605. As is well known in the art, ROM 605 acts to transfer data and instructions uni-directionally to the processor(s) 601, and RAM 604 is used typically to transfer data and instructions in a bi-directional manner. Both of these types of memories may include any suitable of the computer-readable media described below.

A fixed storage 608 is also coupled bi-directionally to the processor(s) 601, optionally via a storage control unit 607. It provides additional data storage capacity and may also include any of the computer-readable media described below. Storage 608 may be used to store operating system 609, EXECs 610, application programs 612, data 611 and the like and is typically a secondary storage medium (such as a hard disk) that is slower than primary storage. It should be appreciated that the information retained within storage 608, may, in appropriate cases, be incorporated in standard fashion as virtual memory in memory 603.

Processor(s) 601 is also coupled to a variety of interfaces such as graphics control 621, video interface 622, input interface 623, output interface, storage interface, and these interfaces in turn are coupled to the appropriate devices. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 601 may be coupled to another computer or telecommunications network 630 using network interface 620. With such a network interface 620, it is contemplated that the CPU 601 might receive information from the network 630, or might output information to the network in the course of performing the above-described method steps. Furthermore, CPU 601 may execute one or more processes of particular embodiments alone or execute one or more processes of particular embodiments over a network 630, such as the Internet, collectively with a remote CPI sharing one or more portions of such processing.

In addition, particular embodiments relate to computer storage products with a computer-readable medium that have computer code thereon for performing various computer-implemented operations. The media and computer code may be those specially designed and constructed for the purposes of the present disclosure, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

As an example and not by way of limitation, the computer system having architecture 600 may provide functionality as a result of processor(s) 601 executing software embodied in one or more tangible, computer-readable media, such as memory 603. Software implementing particular embodiments may be stored in memory 603 and executed by processor(s) 601. A computer-readable medium may include one or more memory devices, according to particular needs. Memory 603 may read the software from one or more other computer-readable media, such as mass storage device(s) 635 or from one or more other sources via communication interface. The software may cause processor(s) 601 to execute particular processes or particular steps of particular processes described herein, including defining data structures stored in memory 603 and modifying such data structures according to the processes defined by the software. In addition or as an alternative, the computer system may provide functionality as a result of logic hardwired or otherwise embodied in a circuit, which may operate in place of or together with software to execute particular processes or particular steps of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method comprising:
accessing software comprising one or more inputs, one or more variables, and one or more segments of code that when executed operate on one or more of the inputs or one or more of the variables;
for every variable:
determining whether the variable is relevant or irrelevant to a set of the inputs when expressed symbolically; and
if the variable is relevant, instrumenting the variable and every one of the segments of code associated with the variable, a segment of code being associated with the variable if the variable affects the segment of code when executed; and
symbolically executing the software with every relevant variable and its associated segments of code as instrumented to test the software.

2. The method of claim 1, wherein:
a variable is relevant to the set of the inputs when expressed symbolically if values of the variable are affected by changes in values of any one of the set of the inputs when expressed symbolically, and
a variable is irrelevant to the set of the inputs when expressed symbolically if values of the variable are unaffected by changes in values of any one of the set of the inputs when expressed symbolically.

3. The method of claim 2, wherein whether a variable in the software is relevant or irrelevant to the set of the inputs when expressed symbolically is determined using static analysis.

4. The method of claim 3, wherein whether a variable in the software is relevant or irrelevant to the set of the inputs when expressed symbolically is determined using relevancy analysis.

5. The method of claim 4, wherein the relevancy analysis is context-sensitive, field-sensitive, and flow-insensitive, and is based on weighted pushdown model checking.

6. The method of claim 5, wherein the software is encoded in JAVA program language, and wherein the relevancy analysis comprises:
converting JAVA code of the software into Jimple code;
constructing a weighted pushdown system model from the Jimple code;
analyzing the weighted pushdown system model; and
performing relevancy analysis to determine variables that are relevant to the set of the inputs when expressed symbolically.

7. The method of claim 1, further comprising for every variable in the software that is relevant to the set of the inputs when expressed symbolically, specifying a symbolic value.

8. The method of claim 7, wherein instrumenting the software comprises:
assigning every variable in the software that is relevant to the set of the inputs when expressed symbolically with the symbolic value specified for the variable; and
assigning every variable in the software that is irrelevant to the set of the inputs when expressed symbolically with a default value.

9. The method of claim 1, further comprising storing information indicating whether each variable in the software is relevant or irrelevant.

10. The method of claim 9, wherein the information is stored using XML (Extensible Markup Language) syntax.

11. The method of claim 1, further comprising verifying the software based on results of the symbolic execution of the instrumented software.

12. A system comprising:
a relevancy analyzer configured to access software comprising one or more inputs, one or more variables, and one or more segments of code that when executed operate on one or more of the inputs or one or more of the variables; and for every variable, determine whether the variable is relevant or irrelevant to a set of the inputs when expressed symbolically;
an instrumenter configured to for every variable, if the variable is relevant, instrument the variable and every one of the segments of code associated with the variable, a segment of code being associated with the variable if the variable affects the segment of code when executed; and
a symbolic executor configured to symbolically execute the software with every relevant variable and its associated segments of code as instrumented to test the software.

13. The system of claim 12, wherein:
a variable is relevant to the set of the inputs when expressed symbolically if values of the variable are affected by changes in values of any one of the set of the inputs when expressed symbolically, and
a variable is irrelevant to the set of the inputs when expressed symbolically if values of the variable are unaffected by changes in values of any one of the set of the inputs when expressed symbolically.

14. The system of claim 13, wherein whether a variable is relevant to the set of inputs when expressed symbolically is determined using a static relevancy analyzer.

15. The system of claim 12, wherein the relevancy analyzer is context-sensitive, field-sensitive, and flow-insensitive, and is based on weighted pushdown model checking.

16. The system of claim 15, wherein the relevancy analyzer comprises:
a Points-to Analysis component;
a call graph component;
an abstraction and modeling component;
a weighted pushdown system component; and
a context-sensitive, field sensitive, and flow-insensitive relevancy analysis component.

17. The system of claim 12, wherein the instrumenter is further configured to assign a symbolic value to every variable in the software that is relevant to the set of the inputs when expressed symbolically, and assign a default value to every variable in the software that is irrelevant to the set of the inputs when expressed symbolically.

18. The system of claim 12, further comprising a symbolic analyzer configured to analyze results produced by the symbolic executor and to verify the software.

19. The system of claim 12, wherein the symbolic executor is further configured to analyze results produced by symbolically executing the instrumented software and to verify the software.

20. One or more computer-readable tangible media embodying software that when executed by one or more computer systems is operable to:
access software comprising one or more inputs, one or more variables, and one or more segments of code that when executed operate on one or more of the inputs or one or more of the variables;
for every variable:
determine whether the variable is relevant or irrelevant to a set of the inputs when expressed symbolically; and
if the variable is relevant, instrument the variable and every one of the segments of code associated with the variable, a segment of code being associated with the variable if the variable affects the segment of code when executed; and
symbolically execute the software with every relevant variable and its associated segments of code as instrumented to test the software.

21. The software embodied in the one or more computer-readable tangible media of claim 20, wherein:
a variable is relevant to the set of the inputs when expressed symbolically if values of the variable are affected by changes in values of any one of the set of the inputs when expressed symbolically, and
a variable is irrelevant to the set of the inputs when expressed symbolically if values of the variable are unaffected by changes in values of any one of the set of the inputs when expressed symbolically.

22. The software embodied in the one or more computer-readable tangible media of claim 21, wherein whether a variable in the software is relevant or irrelevant to the set of the inputs when expressed symbolically is determined using static analysis.

23. The software embodied in the one or more computer-readable tangible media of claim 22, wherein whether a variable in the software is relevant or irrelevant to the set of the inputs when expressed symbolically is determined using relevancy analysis.

24. The software embodied in the one or more computer-readable tangible media of claim 23, wherein the relevancy analysis is context-sensitive, field-sensitive, and flow-insensitive, and is based on weighted pushdown model checking.

25. The software embodied in the one or more computer-readable tangible media of claim 24, wherein the software is encoded in JAVA program language, and wherein the relevancy analysis comprises:
convert JAVA code of the software into Jimple code;
construct a weighted pushdown system model from the Jimple code;
analyze the weighted pushdown system model; and
perform relevancy analysis to determine variables that are relevant to the set of the inputs when expressed symbolically.

26. The software embodied in the one or more computer-readable tangible media of claim 20, wherein the software is further operable to, for every variable in the software that is relevant to the set of the inputs when expressed symbolically, specify a symbolic value.

27. The software embodied in the one or more computer-readable tangible media of claim 26, wherein instrumenting the software comprises:
assign every variable in the software that is relevant to the set of the inputs when expressed symbolically with the symbolic value specified for the variable; and
assign every variable in the software that is irrelevant to the set of the inputs when expressed symbolically with a default value.

28. The software embodied in the one or more computer-readable tangible media of claim 20, wherein the software is further operable to store information indicating whether each variable in the software is relevant or irrelevant.

29. The software embodied in the one or more computer-readable tangible media of claim 28, wherein the information is stored using XML (Extensible Markup Language) syntax.

30. The software embodied in the one or more computer-readable tangible media of claim 20, wherein the software is further operable to validate the software based on results of the symbolic execution of the instrumented software.
